(19) United States
(12) Patent Application Publication
(10) Pub. No.: US 2010/0100282 A1
(43) Pub. Date: Apr. 22, 2010

(54) STRATEGY METHOD FOR REDUCING ENERGY CONSUMPTION OF A MOTOR VEHICLE

(75) Inventors: Sébastien Chapeau, Nice (FR); Yohann Aubert, Champigny Sur Marne (FR)

Correspondence Address: LEYDIG VOIT & MAYER, LTD, 700 THIRTEENTH ST. NW, SUITE 300, WASHINGTON, DC, 20005-3960, US

(73) Assignee: JTEKT HPI, Chennevieres Sur Marne (FR)

(21) Appl. No.: 12/557,598

(22) Filed: Sep. 11, 2009

(30) Foreign Application Priority Data
Sep. 11, 2008 (FR) 0856125

(51) Int. Cl. B62D 6/00

(52) U.S. Cl. 701/42; 701/41

(57) ABSTRACT

A method for reducing energy consumption of a motor vehicle having a power steering system including a electro-pump device (GEP) and for establishing set speeds of the electro-pump device depending on parameters of the operation of the vehicle, intended to be applied to the electro-pump device during a normal operating mode. At least one additional specific operating mode is defined, during which the speed of the electro-pump device is reduced to a level where the driver does not yet experience discomfort during driving and applies to the electro-pump device suitable set speeds when the vehicle operates according to the specific operating mode.

### FIELD OF THE INVENTION

The invention relates to a strategic method for reducing the energy consumption of a motor vehicle comprising a power steering system equipped with an electro-pump device comprising a pump and an electric motor for driving into rotation the pump and adapted so as to establish set speed values of the electro-pump unit depending on the speed of the vehicle and on the speed of the steering wheel and intended to be applied to the electro-pump unit during a so-called normal operating mode.

### BACKGROUND

Methods of this type are already known but only provide a partial reduction in energy consumption, notably in electric energy consumed by the electro-pump unit.

### SUMMARY OF THE INVENTION

The object of the invention is to overcome this drawback.

In order to achieve this object, the method according to the invention is characterized in that at least one additional specific operating mode is defined during which the speed of the electro-pump unit is advantageously reduced down to a level where the driver does not yet experience any discomfort upon driving and applies to the electro-pump unit suitable set speed values when the vehicle operates according to this specific operating mode.

The discomfort avoided by the present invention would be expressed by the overtorque which the driver would have to apply to the steering wheel during maneuvers requiring a rapid change in the angular position of the steering wheel, for example when he/she has to suddenly avoid an obstacle.

According to an additional feature of the invention, the operating parameters of the vehicle are the speed of the vehicle, the angular speed and position of the steering wheel.

According to another feature of the invention, a so-called standby mode is provided as a specific mode and entering this mode from the normal mode is defined by a predetermined low vehicle speed threshold, an electric motor current threshold value which depends on the speed of the vehicle, and a range of the steering wheel angle.

According to still another feature of the invention, leaving the standby mode and returning to the normal mode is carried out when the current of the electric motor is equal to or greater than a threshold value, or the absolute angular position of the steering wheel is comprised between two predetermined values or the angular speed of the steering wheel is equal to or greater than a predetermined speed.

According to still another feature of the invention, a so-called stopping mode is provided and entering this mode from the normal mode is accomplished when the vehicle speed is less than a predetermined low speed, the current of the motor is less than or equal to a threshold value and the angular position of the steering wheel is located in a range of predetermined low values and the set speed given to the electro-pump group specific to this mode represents stopping the electric motor.

According to still another feature of the invention, leaving the stopping mode and returning to the normal mode is carried out when the speed of the vehicle is greater than or equal to a predetermined low speed value or the angular position of the steering wheel is outside a range of predetermined values.

According to still another feature of the invention, switching-over between the standby mode and the stopping mode is provided at predetermined operating parameters of the vehicle.

According to still another feature of the invention, a so-called abutment mode is provided, the entering of which from the normal mode is accomplished when the speed of the vehicle is less than a predetermined low value, the current of the motor is greater than a threshold value and the angular position of the steering wheel is equal to or greater than a predetermined large angle value.

According to still another feature of the invention, the set speed consists in a value of the speed of rotation of the electro-pump group depending on angular position values of the steering wheel.

According to still another feature of the invention, leaving the abutment mode and returning to the normal mode is accomplished when the speed of the vehicle is equal to or greater than a predetermined value or the angular position of the steering wheel is less than a predetermined value, or the speed of the steering wheel is greater than a predetermined value.

According to still another feature of the invention, the set speed value is given to the electro-pump unit when the conditions for entering this mode are met for a predetermined time period, except for the abutment mode.

According to still another feature of the invention, the predetermined low speed value of the vehicle is the same for the specific operating modes.

### BRIEF DESCRIPTION OF DRAWING FIGURES

The invention will be better understood and other objects, features, details and advantages thereof will become more clearly apparent in the explanatory description which follows and which is made with reference to the appended schematic drawings only given as an example illustrating several embodiments of the invention and wherein:

FIG. 1 schematically illustrates the determination of the set speed of the electro-pump unit, according to the method of the invention;

FIG. 2 illustrates as a block diagram the interrelationship of the different operating modes, according to the method of the invention;

FIG. 3 schematically illustrates the switching-over between the normal operating mode and the so-called “standby” specific operating mode, in accordance with the method according to the invention;

FIG. 4 schematically illustrates the switching-over between the normal operating mode and the so-called “stopping” specific operating mode, in accordance with the method of the invention;

FIG. 5 schematically illustrates the switching-over between the specific “standby” mode and the specific “stopping” mode, and

FIG. 6 schematically illustrates the switching between the normal mode and the so-called “abutment” specific mode, in accordance with the method of the invention.

### DETAILED DESCRIPTION

The invention relates to motor vehicles equipped with a notably electro-hydraulic power steering system. Such a system typically comprises a pump intended to send pressurized liquid, usually oil, into a hydraulic actuator which then produces an assisting torque to be applied to the steering column. The pump is driven into rotation by an electric motor and the assembly formed by the pump and the motor is called an electro-pump unit (GEP).

The set speed values of the GEP are determined according to the speed of the motor vehicle and the angular speed of the steering wheel, for controlling the steering column and are established for different pairs of these two values. The speed of the vehicle and the angular speed of the steering wheel are established by measurements with suitable sensors of the speed of the vehicle and of the angular displacement of the steering column.

Table I indicates the set values, in turns or revolutions per minute, of the speed to be given to the electro-pump unit, more specifically to the electric motor thereof, associated with different pairs of speed values of the vehicle and of the steering wheel. Table I gives relevant values reflecting normal operation. From this table, the system determines the set value for a pair of operating values of the vehicle, which will then be applied to the GEP when the speed sensors of the vehicle and of the steering wheel measure both of these values relating to the operation of the vehicle. This table was established with a concern for reducing notably electrical energy consumption of the GEP.

TABLE I
VEHICLE SPEED (Vᵥₑₕ) in km/h

| | | 0 | 30 | 70 | 90 | 110 | 140 | 200 |
|---|---|---|---|---|---|---|---|---|
| STEERING | 0 | 2500 | 3500 | 2300 | 2000 | 1610 | 1225 | 1025 |
| WHEEL | 25 | 2500 | 3500 | 2300 | 2000 | 1610 | 1225 | 1025 |
| SPEED in | 50 | 2500 | 3500 | 2300 | 2000 | 1610 | 1225 | 1025 |
| degrees/sec. | 100 | 2500 | 3500 | 2300 | 2000 | 1610 | 1225 | 1025 |
| | 300 | 2800 | 4600 | 4600 | 4200 | 4000 | 4000 | 3500 |
| | 500 | 4000 | 4700 | 4700 | 4650 | 4390 | 4130 | 3920 |
| | 750 | 4700 | 4700 | 4700 | 4700 | 4700 | 4700 | 4750 |
| | | 5167 | 5167 | 5167 | 5167 | 5167 | 5167 | 5167 |

Set values in rpm

The invention is based on the discovery that, in certain specific operating modes, the consumption of (electric) energy by the electric motor of the GEP and of fuel by the heat engine may be considerably reduced by lowering the speed of rotation of the electric motor, without the driver experiencing any discomfort.

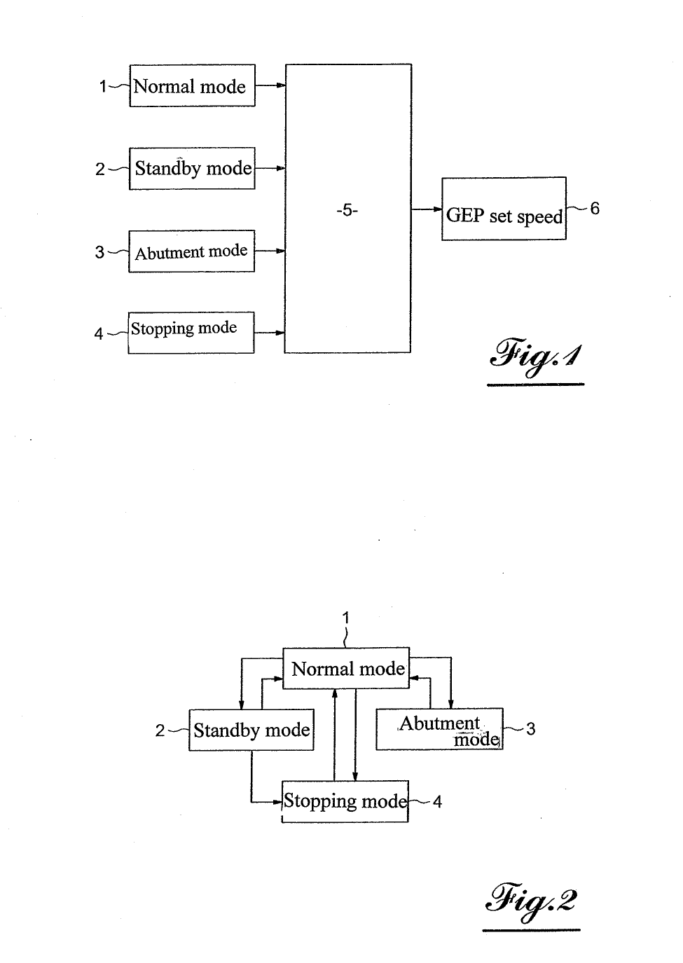

These particular modes will be described hereafter by specifying them with their characteristic parameters. Thus, as a non-limiting example, three operating modes are defined, i.e. a so-called “standby” mode, a so-called “stopping” mode, a so-called “abutment” mode, the interrelationship of which is illustrated in FIG. 2.

In FIG. 1, the boxes 1, 2, 3, 4 illustrate operation in the normal mode, in the standby mode, in the abutment mode and in the stopping mode, respectively. The four modes are connected to a mode selector 5 which, depending on the operating data measured in real time on the vehicle, selects from the four possible modes the mode which corresponds to these data and which then transmits to the electro-pump unit the set speed value representative of the selected mode, as illustrated by the GEP set speed box 6.

More specifically, according to FIG. 2, the invention provides the possibility of switching-over in both directions, between the normal mode 1 and the standby mode 2, between the normal mode 1 and the stopping mode 4 and between the normal mode 1 and the abutment mode 3. Further, simple switching-over from the standby mode 2 to the stopping mode 4 is provided. The different possible switchovers are indicated by arrowed lines.

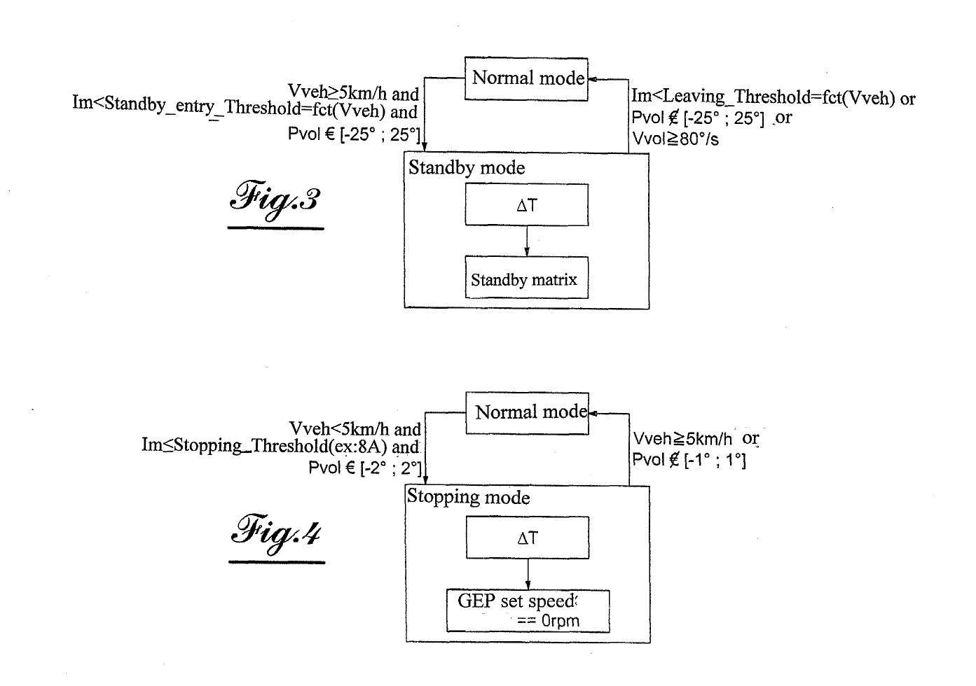

FIG. 3 specifically illustrates the switching-over between the normal mode and the standby mode, and indicates the conditions which determine this switchover. Three conditions determine the switching-over from the normal mode to the “standby” mode. The switchover i.e. entering this standby mode, occurs when the speed Vveh of the vehicle is equal to or greater than 5 km/h. The current Im of the electric motor of the GEP is less a threshold value and the value of the absolute angular position Pvol of the steering wheel is comprised between −25° and +25°. The threshold value of the current depends on the speed of the vehicle. Table II as an example gives values of the speed of the vehicle Vveh in km/h and of the associated current threshold in Amperes (A). This table therefore gives the current threshold for entering the standby mode. The table by linear interpolation allows determination of the current threshold associated with each speed value of the vehicle. The values may be set or recalculated during a mission. It should be noted that the values are only given as an example.

TABLE II

| | Vehicle speed (km/h) | | | | | |
|---|---|---|---|---|---|---|
| | 5 | 25 | 50 | 100 | 140 | 180 |
| Threshold for entering standby | 8 | 8 | 7 | 7 | 6 | 5 |
| mode (A) | | | | | | |

If the conditions for entering the standby mode are met, the invention provides a timing phase ΔT for launching the standby phase. The mode is set up when the three entry conditions have been met during the timing period. If yes, the method according to the invention orders the application of the specific set speed values of the standby mode to the electro-pump. These values are established from Table III which represents the “standby” matrix. This matrix indicates the set values depending on the speed of the vehicle Vveh and on the angular position Pvol of the steering wheel.

TABLE III

| | | VEHICLE SPEED (Vᵥₑₕ) in km/h | | | | | |
|---|---|---|---|---|---|---|---|
| Standby matrix | | 5 | 25 | 50 | 100 | 140 | 180 |
| STEERING WHEEL POSITION | −25 | 6000 | 6000 | 6000 | 6000 | 6000 | 6000 |
| (Pᵥₒₗ) in degrees | −20 | 6000 | 6000 | 6000 | 1909 | 1430 | 1395 |
| | −15 | 3000 | 3000 | 2000 | 1243 | 1150 | 973 |
| | −12 | 2370 | 2360 | 1770 | 1151 | 1080 | 885 |
| | −10 | 2000 | 2000 | 1610 | 1120 | 1040 | 858 |
| | −7 | 1500 | 1500 | 1500 | 1080 | 984 | 827 |
| | −5 | 1300 | 1300 | 1150 | 1070 | 950 | 816 |
| | −2 | 1100 | 1100 | 1000 | 1054 | 907 | 802 |
| | 0 | 1000 | 1000 | 1000 | 1000 | 900 | 800 |
| | 2 | 1100 | 1100 | 1000 | 1054 | 907 | 802 |
| | 5 | 1300 | 1300 | 1150 | 1070 | 950 | 816 |
| | 7 | 1500 | 1500 | 1500 | 1080 | 984 | 827 |
| | 10 | 2000 | 2000 | 1610 | 1120 | 1040 | 858 |
| | 12 | 2370 | 2360 | 1770 | 1151 | 1080 | 885 |
| | 15 | 3000 | 3000 | 2000 | 1243 | 1150 | 973 |
| | 20 | 6000 | 6000 | 6000 | 1909 | 1430 | 1395 |
| | 25 | 6000 | 6000 | 6000 | 6000 | 6000 | 6000 |

Set values in rpm

The method according to the invention provides the leaving of the standby mode and returning to the normal mode when one of the three following conditions is ascertained, either the current of the electric motor is equal to or greater than the threshold value for leaving the standby mode, or the absolute angular position of the steering wheel is outside a range comprised between −25° and +25°, or the angular speed of the steering wheel is equal to or greater than 80°/s. The threshold value of the current depends on the speed of the vehicle and is indicated by Table IV. This value may be set or recalculated during a mission.

TABLE IV

| | Vehicle speed (km/h) | | | | | |
|---|---|---|---|---|---|---|
| | 5 | 25 | 50 | 100 | 140 | 180 |
| Threshold for leaving standby | 4 | 4 | 3 | 3 | 3 | 3 |
| mode (A) | | | | | | |

FIG. 4 illustrates the switching-over between the normal mode and the stopping mode by indicating the conditions for entering this mode and for leaving the latter. In order to switch over from the normal mode to the stopping mode, the speed Vveh of the vehicle has to be less than 5 km/h, the current Im of the electric motor has to be less than or equal to the stopping threshold which, for example, is 8 amperes and the relative angular position of the steering wheel has to be comprised between −2° and +2°. The stopping mode is launched after a timing period ΔT and the set speed is forced to 0 rpm (number of revolutions per minute), which means stopping the electric motor. Leaving the stopping mode and returning to the normal mode is accomplished when the speed of the vehicle is equal to or greater than 5 km/h or the relative angular position Pvol of the steering wheel is outside a range comprised between −1° and +1°.

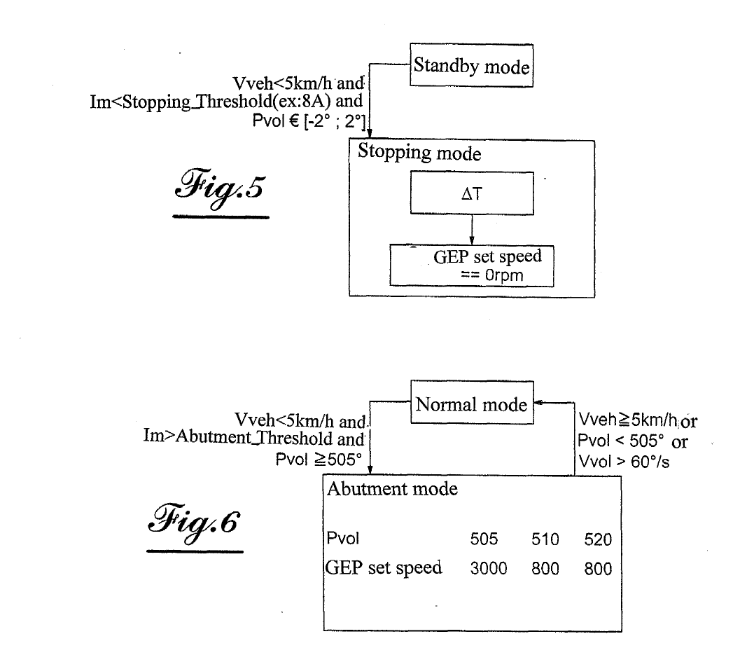

FIG. 5 relates to the interrelationship between the standby mode and the stopping mode. When the vehicle operates according to the standby mode, and the speed of the vehicle Vveh is less than 5 km/h and the current Im of the electric motor is less than or equal to the stopping threshold (for example 8 A) and the relative angular position of the steering wheel is comprised between −2+ and +2°, the stopping mode is launched, after a timing period ΔT. The set speed is forced to 0 rpm, i.e. the stopping of the motor. Return to the normal mode is accomplished as this is indicated in the description of FIG. 4.

FIG. 6 illustrates the switching-over between the normal mode and the abutment mode. Entering the abutment mode is accomplished without any timing ΔT, when the speed of the vehicle Vveh is less than 5 km/h and the current Im of the electric motor is larger than the abutment threshold value which for example is 50 A and the position of the steering wheel is larger than or equal to 505°. The abutment mode then provides depending on the angular position of the steering wheel Pvol of 505°, 510°, 520°, the set speed of 3,000, 800 and 800 rpm respectively, as this is indicated. Leaving the abutment mode and returning to the normal mode is performed when the speed of the vehicle Vveh is greater than or equal to 5 km/h or the angular position of the steering wheel Pvol is less than 505° or the angular speed Pvol of the steering wheel is greater than 60°/s.

Of course, all the values which have been given hereinbefore are given as an example and other values may be retained, provided however that the reduction in the speed of rotation of the electric motor of the electro-pump unit does not cause substantial discomfort for the driver or is felt as such by the latter.

Indeed, the set values for the speed of rotation of the electric motor of the electro-pump unit have to be determined so that reactivity of the power steering system during a change in the operating mode is not degraded. In practical terms, this means that the rotational speed of the electric motor of the electro-pump unit should not be reduced to the point that the power steering system would not be able to react fast enough. The discomfort which the driver would experience, would then consist in a greater effort which he/she would have to produce in order to be able to turn the steering wheel very rapidly, for example when the question is of avoiding an obstacle suddenly standing in front of the vehicle.

With the invention it is possible to make considerable energy savings without such a discomfort being produced. This is confirmed by tests with the same vehicle, once by operating the latter according to the normal mode and then according to the specific operating mode defined by the invention. In the normal mode, an average current consumption of 3.83 amperes and an average voltage during the test of 14.09 Volts which gives an average consumed power of 54 Watts, were reported. During operation according to the invention, the average current consumption was 0.72 A, the average voltage during the test was 13.88 Volts and the average consumed power was 10 W. Thus, by applying the invention, an average gain over the standardized cycle (known to one skilled in the art under the terms of NMVEG type) of 44 W was obtained.

1. A strategy method for reducing energy consumption of a motor vehicle comprising a power steering system including an electro-pump device, the electro-pump device including a pump and an electric motor for driving the pump for establishing speed values of the electro-pump device depending on operating parameters of the motor vehicle, applied to the electro-pump unit in an operating mode, referred to as a normal mode, the method including defining at least one specific operating mode of the motor vehicle during which the speed of the electro-pump device is reduced to a level at which a driver of the motor vehicle does not experience discomfort during driving and set speeds are applied to the electro-pump device.

2. The method according to claim 1, wherein the operating parameters of the motor vehicle are speed of the motor vehicle, and angular speed and position of the motor vehicle's steering wheel.

3. The method according to any of claim 1, wherein the specific mode is a standby mode and including entering the standby mode from the normal mode upon reaching a low motor vehicle speed threshold, and an electric motor current below a motor current threshold value, which depends on the speed of the motor vehicle, while within in an angular range of the motor vehicle's steering wheel.

4. The method according to claim 3, including leaving the standby mode and returning to the normal mode when the current of the electric motor increases to at least the motor current threshold value, or the angular position of the steering wheel is between two predetermined values, or angular speed of the steering wheel is at least a predetermined angular speed.

5. The method according to claim 3, including a stopping mode and entering the stopping mode from the normal mode when the speed of the motor vehicle is less than a predetermined low speed, electrical current of the electric motor decreases to below the threshold electric current value, and angular position of the motor vehicle's steering wheel is in a predetermined range and the set speed applied to the electro-pump device in the stopping mode represents stopping of the electric motor.

6. The method according to claim 5, including leaving the stopping mode and returning to the normal mode when the speed of the motor vehicle is at least the predetermined low speed or the angular position of the steering wheel is outside the predetermined range.

7. The method according to claim 5, wherein changing between the standby mode and the stopping mode occurs at predetermined operating parameters of the vehicle.

8. The method according to claim 1, including an abutment mode and including entering the abutment mode from the normal mode when the speed of the motor vehicle is less than a predetermined low value, electric current of the electric motor is greater than a threshold electric current value and angular position of the motor vehicle's steering wheel is at least a predetermined angle.

9. The method according to claim 8, wherein the set speeds are speeds of rotation of the electro-pump device that depend on the angular position of the steering wheel.

10. The method according to claim 8, including leaving the abutment mode and returning to the normal mode when the speed of motor vehicle is at least a predetermined value, or the angular position of the steering wheel is less than a predetermined value, or angular speed of the steering wheel is greater than a predetermined value.

11. The method according to claim 8, wherein one of the set speeds is given to the electro-pump device when conditions for entering one of the specific operating modes are met during a predetermined time period, except for entering the abutment mode.

12. The method according to claim 8, wherein the predetermined low speed of the motor vehicle is the same for all the specific operating modes.
